(19) United States
(12) Patent Application Publication
(10) Pub. No.: US 2026/0300077 A1
(43) Pub. Date: Oct. 1, 2026

(54) MANAGING TELEMETRY DATA COLLECTION AT AN INFORMATION HANDLING SYSTEM

(71) Applicant: Dell Products L.P., Round Rock, TX (US)

(72) Inventors: Alan Helmy Abdelhalim, Pflugerville, TX (US); Jacob Vincent Mink, Cedar Park, TX (US); Yves Christian Dolce, Redmond, WA (US)

(21) Appl. No.: 19/089,541

(22) Filed: Mar. 25, 2025

(51) Int. Cl. G06F 11/07; H04L 41/082

(52) U.S. Cl. CPC G06F 11/0793; H04L 41/082

(57) ABSTRACT

Managing telemetry data collection at an information handling system, including receiving, from a first collector computing module, a request for a value of a first datatype of the telemetry data; in response to receiving the request: registering the first collector computing module as a subscriber of the first datatype of the telemetry data; providing, to the first collector computing module, an initial value for the first datatype of the telemetry data; obtaining, at a second time after the first time, subsequent values of each of the plurality of datatypes of the telemetry data; determining that the subsequent value of the first datatype is different from the initial value of the first datatype, and in response: identifying subscribers of the first datatype of the telemetry data; providing, automatically and without user input and to the first collector computing module, the subsequent value of the first datatype of the telemetry data.

### BACKGROUND

### Field of the Disclosure

The disclosure relates generally to an information handling system, and in particular, managing telemetry data collection at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Telemetry data collection involves the gathering and transmission of data from various sensors and devices to a central system for monitoring and analysis. This data can include information on system performance, environmental conditions, and user interactions. Telemetry is widely used in fields such as aerospace, healthcare, and IT to ensure systems are functioning correctly and to predict potential issues. By analyzing telemetry data, organizations can make informed decisions, improve efficiency, and enhance overall system reliability.

### SUMMARY

Innovative aspects of the subject matter described in this specification may be embodied in a method of managing telemetry data collection at an information handling system, including identifying a plurality of datatypes of telemetry data, each datatype of the plurality of datatypes of telemetry data associated with computing hardware of the information handling system; obtaining, at a first time and from the computing hardware, initial values of each of the plurality of datatypes of the telemetry data; storing, at a table, the initial values of each of the plurality of datatypes of the telemetry data; receiving, from a first collector computing module, a request for a value of a first datatype of the plurality of datatypes of the telemetry data; in response to receiving the request: registering the first collector computing module as a subscriber of the first datatype of the telemetry data; providing, to the first collector computing module, the initial value indicated by the table for the first datatype of the telemetry data; obtaining, at a second time after the first time, subsequent values of each of the plurality of datatypes of the telemetry data; comparing, for the first datatype of the telemetry data, the initial value of the first datatype to the subsequent value of the first datatype; determining, based on the comparing, that the subsequent value of the first datatype is different from the initial value of the first datatype, and in response: updating, at the table for the first datatype of the telemetry data, the initial value to the subsequent value; identifying, based on the table, one or more subscribers of the first datatype of the telemetry data; providing, automatically and without user input and to the first collector computing module, the subsequent value of the first datatype of the telemetry data; and performing, at the first collector computing module and based on the subsequent value of the first datatype of the telemetry data, a remediation action at one or more of the computing hardware of the information handling system.

Other embodiments of these aspects include corresponding systems, apparatus, and computer programs, configured to perform the actions of the methods, encoded on computer storage devices.

These and other embodiments may each optionally include one or more of the following features. For instance, providing data indicating the table to the collector computing modules of the information handling system. Determining, based on the comparing, that the subsequent value of the first datatype is the same as the initial value of the first datatype, and in response: obtaining, at a third time after the second time, further subsequent values of each of the plurality of datatypes of the telemetry data. Comparing, for the first datatype, the subsequent value of the first datatype to the further subsequent value of the first datatype; determining, based on the comparing, that the further subsequent value of the first datatype is different from the subsequent value of the first datatype, and in response: updating, at the table for the first datatype, the subsequent value to the further subsequent value; identifying, based on the table, one or more subscribers of the first datatype of the telemetry data; providing, automatically and without user input and to the first collector computing module, the further subsequent value of the first datatype of the telemetry data; and performing, at the first collector computing module and based on the further subsequent value of the first datatype of the telemetry data, a remediation action at one or more of the computing hardware of the information handling system.

Particular implementations of the subject matter described in this specification can be implemented so as to realize one or more of the following advantages. For example, performance and reliability are improved by avoiding duplicate collections, reducing code development and maintenance costs, and enabling decentralized, extensible data collection and centralized telemetry management; enhancing performance and ensuring the system runs more efficiently by avoiding unnecessary duplicate calls.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing telemetry data collection.

FIG. 3 illustrates a method for managing telemetry data collection at an information handling system.

### DESCRIPTION OF PARTICULAR EMBODIMENT(S)

This disclosure discusses methods and systems for managing telemetry data collection of an information handling system. In short, due to varying hardware configurations and form factors, some information handling systems have certain datatypes available while others do not. The present invention provides a centralized location for common data within a distributed telemetry collection service; and instead of requiring consumers to “pull” the telemetry data, a “push model” is employed. This ensures that any state changes are immediately relayed to consumers based on their subscriptions.

Specifically, this disclosure discusses a system and a method for managing telemetry data collection at an information handling system, including identifying a plurality of datatypes of telemetry data, each datatype of the plurality of datatypes of telemetry data associated with computing hardware of the information handling system; obtaining, at a first time and from the computing hardware, initial values of each of the plurality of datatypes of the telemetry data; storing, at a table, the initial values of each of the plurality of datatypes of the telemetry data; receiving, from a first collector computing module, a request for a value of a first datatype of the plurality of datatypes of the telemetry data; in response to receiving the request: registering the first collector computing module as a subscriber of the first datatype of the telemetry data; providing, to the first collector computing module, the initial value indicated by the table for the first datatype of the telemetry data; obtaining, at a second time after the first time, subsequent values of each of the plurality of datatypes of the telemetry data; comparing, for the first datatype of the telemetry data, the initial value of the first datatype to the subsequent value of the first datatype; determining, based on the comparing, that the subsequent value of the first datatype is different from the initial value of the first datatype, and in response: updating, at the table for the first datatype of the telemetry data, the initial value to the subsequent value; identifying, based on the table, one or more subscribers of the first datatype of the telemetry data; providing, automatically and without user input and to the first collector computing module, the subsequent value of the first datatype of the telemetry data; and performing, at the first collector computing module and based on the subsequent value of the first datatype of the telemetry data, a remediation action at one or more of the computing hardware of the information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

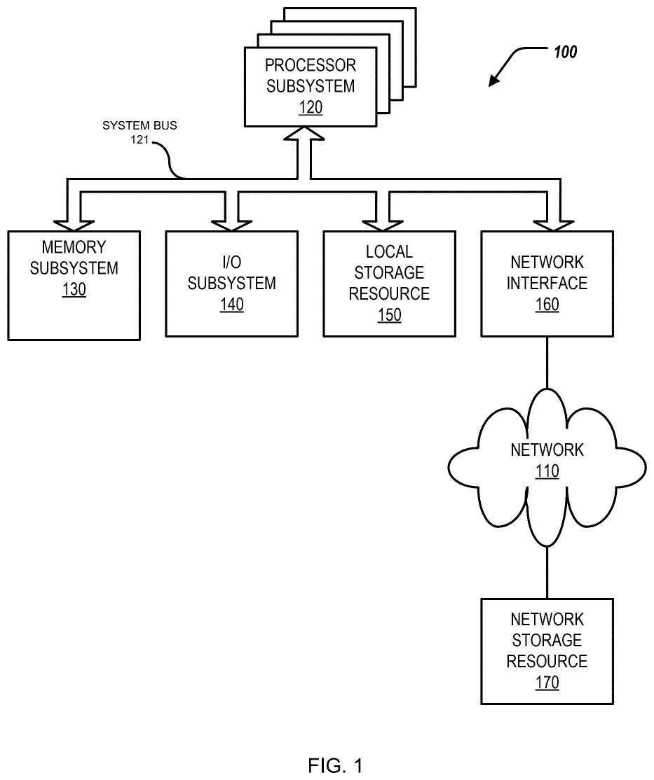

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

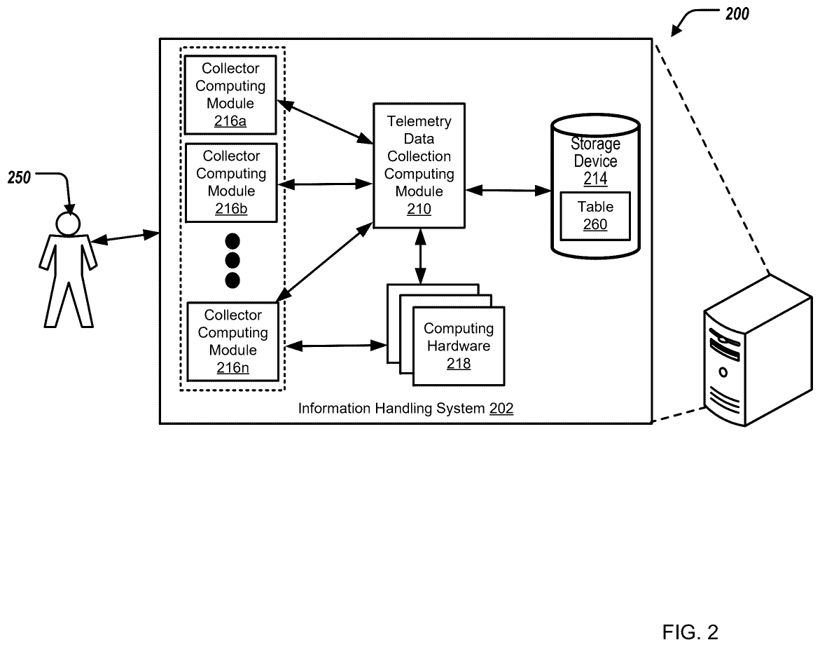

Turning to FIG. 2, FIG. 2 illustrates an environment 200 including an information handling system 202. The information handling system 202 can include a telemetry data collection computing module 210, collector computing modules 216a, 216b, . . . , 216n (collectively referred to as collector computing modules 216), a storage device 214, and computing hardware 218. In some examples, the information handling system 202 is similar to, or includes, the information handling system 100 of FIG. 1.

The telemetry data collection computing module 210 can be in communication with the collector computing modules 216, the storage device 214, and the computing hardware 218. The collector computing modules 216 can be in communication with the telemetry data collection computing module 210.

The computing hardware 218 can include memory, storage devices, video cards, audio cards, processors, and the like.

In short, due to varying hardware configurations and form factors, some information handling systems have certain datatypes available while others do not. The present invention provides a centralized location for common data within a distributed telemetry collection service; and instead of requiring consumers to “pull” the telemetry data, a “push model” is employed. This ensures that any state changes are immediately relayed to consumers based on their subscriptions.

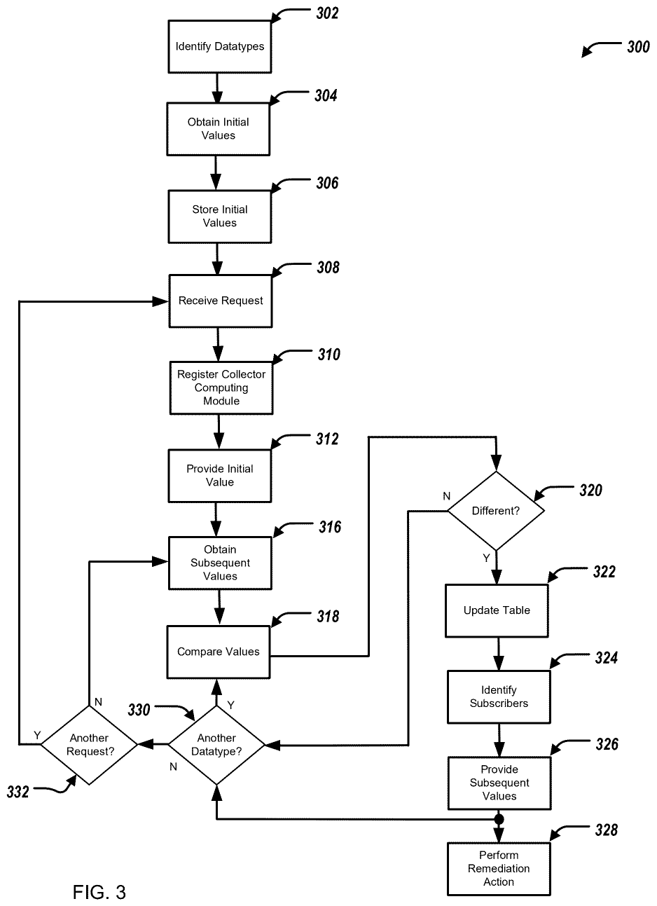

FIG. 3 illustrates a flowchart depicting selected elements of an embodiment of a method 300 for managing telemetry data collection. The method 300 may be performed by the information handling system 100, the information handling system 202, and/or the telemetry data collection computing module 210, and with reference to FIGS. 1-2. It is noted that certain operations described in method 300 may be optional or may be rearranged in different embodiments.

The telemetry data collection computing module 210 can identify a plurality of datatypes of telemetry data, at 302. Each datatype of the telemetry data is associated with the computing hardware 218. That is, the telemetry data can represent properties, parameters, and the like, of the computing hardware 218. For example, the telemetry data can include processor parameters, temperature of the computing hardware 218, processing parameters of the computing hardware 218, data access parameters of memory, battery information, battery state, network performance parameters and speed, BIOS version, OS version, and the like.

The telemetry data collection computing module 210 can obtain, at a first time and from the computing hardware 218, initial values of each of the plurality of datatypes of the telemetry data, at 304. That is, the telemetry data collection computing module 210 contacts the computing hardware 218, and polls (invokes) the computing hardware 218 for initial values of the respective telemetry data associated with each of the computing hardware 218.

The telemetry data collection computing module 210 can store, at a table 260 stored at the storage device 214, the initial values of each of the plurality of datatypes of the telemetry data, at 306. That is, the telemetry data collection computing module 210 can update the table 260 to indicate, for each datatype of telemetry data, the initial value of the datatype based on the collection of such from the computing hardware 218. For example, the initial values can include a temperature of the processor, a network processing speed, a battery charge level, and the like.

In some examples, the telemetry data collection computing module 210 can provide data indicating the table 260 to the collector computing modules 216. That is, the telemetry data collection computing module 210 can “publish” the table 260, or a portion of the table 260, or an availability of the table 260. That is, the telemetry data collection computing module 210 can provide data indicating the table 260, or a portion of the table 260, or an availability of the table 260 to the collector computing modules 216. The portion of the table 260 can include the datatypes of the telemetry data that is available, or an indication of the datatypes of the telemetry data that is available. The telemetry data collection computing module 210 can dynamically publish the table 260 to the collector computing modules 216 such that the collector computing modules 216 can subscribe to updates to the values of the telemetry data that are appropriate for each collector computing module 216, as described further herein.

The telemetry data collection computing module 210 receives, from the collector computing module 216a, a request, at 308. Specifically, the telemetry data collection computing module 210 receives, from the collector computing module 216a, a request for a value of a first datatype of the datatypes of the telemetry data. The telemetry data collection computing module 210, in response to receiving the request from the collector computing module 216a, registers the collector computing module 216a as a subscriber of the first datatype of the telemetry data, at 310. That is, the telemetry data collection computing module 210 updates the table 260 to add the collector computing module 216a as a subscriber of the first datatype of the telemetry data. That is, the table 260 can indicate for the first datatype of the telemetry data, the current value of the first datatype of the telemetry data and the computing modules that subscribe to updates to the values of the first datatype of telemetry data. Thus, when sampling/polling of the first datatype of the telemetry data occurs or when event-based update to the telemetry data occurs, the telemetry data collection computing module 210 can facilitate providing the value of the first datatype of the telemetry data to the collector computing module 216a, as described further herein.

The telemetry data collection computing module 210, further in response to receiving the request from the collector computing module 216a, provides, to the collector computing module 216a, the initial value indicated by the table 260 for the first datatype of telemetry data, at 312.

The telemetry data collection computing module 210 can obtain, at a second time after the first time and from the computing hardware 218, subsequent values of each of the plurality of datatypes of the telemetry data, at 316. That is, the telemetry data collection computing module 210 contacts the computing hardware 218, and polls (invokes) the computing hardware 218 for subsequent values of the respective telemetry data associated with each of the computing hardware 218.

In some examples, the telemetry data collection computing module 210 can obtain the subsequent values of each of the plurality of datatypes of the telemetry data based on a sampling frequency associated with each of the datatypes. Specifically, the table 260 can include data indicating a plurality of datatypes of telemetry data, and for each datatype of the plurality of datatypes, a sampling frequency of the datatype of telemetry data. For example, for datatype A, the table 260 can indicate a sampling frequency Z; and for datatype B, the table 260 can indicate a sampling frequency Y; and so forth. The sampling frequency of each datatype of telemetry data can indicate how often each datatype of telemetry data is collected/sampled by the telemetry data collection computing module 210. For example, the sampling frequency can be 1 minute, 1 hour, or 1 day. The table 260 can include data indicating the sampling frequency for each datatype of telemetry data.

In some examples, the telemetry data collection computing module 210 can obtain the subsequent values of one or more of the plurality of datatype of the telemetry data in response to a respective event associated with the one or more of the plurality of datatype of the telemetry data. Specifically, for one or more of the datatypes of the telemetry data, the datatype can be associated with an event condition. For example, the event condition can include a power state change (AC or DC). When the event condition occurs that is associated with a datatype of telemetry data, the telemetry data collection computing module 210 obtains the subsequent value of the datatype of telemetry data. That is, the subsequent value of the datatype of the telemetry data is pushed to the telemetry data collection computing module 210 when the event condition for the datatype of the telemetry data occurs. In other words, the telemetry data collection computing module 210 subscribes to updates of the datatype of telemetry data when an event condition occurs.

The telemetry data collection computing module 210 can compare, for each datatype of telemetry data, the initial value of the datatype to the subsequent value of the datatype, at 318. Specifically, the telemetry data collection computing module 210 can compare, for the first datatype of telemetry data, the initial value of the first datatype to the subsequent value of the first datatype. The telemetry data collection computing module 210 can determine, based on the comparing, whether the subsequent value of the first datatype is different from the initial value of the first datatype, at 320.

In some examples, the telemetry data collection computing module 210 can determine that the subsequent value of the first datatype is different from the initial value of the first datatype (at 320), and in response, update the table 260 for the first datatype of the telemetry data, at 322. Specifically, the telemetry data collection computing module 210 updates, at the table 260 for the first datatype of the telemetry data, the initial value to the subsequent value when the subsequent value of the first datatype is different from the initial value of the first datatype.

The telemetry data collection computing module 210 can identify, based on the table 260, one or more subscribers of the first datatype of the telemetry data, at 324. The table 260 can indicate, for each datatype of telemetry data, subscribers of the telemetry data. For example, for the first datatype of telemetry data, the table 260 can indicate that the collector computing module 216a is a subscriber of the first datatype of telemetry data.

The telemetry data collection computing module 210 can provide, automatically and without user input and to the collector computing module 216, the subsequent value of the first datatype of the telemetry data, at 326. That is, the telemetry data collection computing module 210 can provide, to the collector computing module 216a, a notification that the value of the first datatype of the telemetry data has changed, and further provide the subsequent value for the first datatype of the telemetry data. The telemetry data collection computing module 210 can provide the subsequent value of the first datatype of the telemetry data in response to determining that the subsequent value of the first datatype is different from the initial value of the first datatype (at 320). That is, the telemetry data collection computing module 210 “pushes” the subsequent value of the first datatype of the telemetry data to the collector computing module 216a automatically and without a “pull” request from the collector computing module 216a for each update of the value of the first datatype of the telemetry data. In other words, the telemetry data collection computing module 210 can provide the subsequent value of the first datatype of the telemetry data to the collector computing module 216a automatically and without a request from the collector computing module 216a (outside of a request from the collector computing module 216a to be a subscriber of the first datatype of the telemetry data).

Furthermore, the telemetry data collection computing module 210 can provide, automatically and without user input and to the one or more subscribers of the first datatype of the telemetry data as indicated by table 260, the subsequent value of the first datatype of the telemetry data. That is, the telemetry data collection computing module 210 can provide, to the one or more subscribers of the first datatype of the telemetry data as indicated by table 260, a notification that the value of the first datatype of the telemetry data has changed, and further provide the subsequent value for the first datatype of the telemetry data. The telemetry data collection computing module 210 can provide the subsequent value of the first datatype of the telemetry data in response to determining that the subsequent value of the first datatype is different from the initial value of the first datatype (at 320). That is, the telemetry data collection computing module 210 “pushes” the subsequent value of the first datatype of the telemetry data to the one or more subscribers of the first datatype of the telemetry data as indicated by table 260 automatically and without a “pull” request from the one or more subscribers of the first datatype of the telemetry data as indicated by table 260 for each update of the value of the first datatype of the telemetry data. In other words, the telemetry data collection computing module 210 can provide the subsequent value of the first datatype of the telemetry data to the one or more subscribers of the first datatype of the telemetry data as indicated by table 260 automatically and without a request from the one or more subscribers of the first datatype of the telemetry data as indicated by table 260 (outside of a request from the one or more subscribers of the first datatype of the telemetry data as indicated by table 260 to be a subscriber of the first datatype of the telemetry data).

The collector computing module 216a can perform, based on the subsequent value of the first datatype of the telemetry data, a remediation action at the computing hardware 218, at 328. That is, the collector computing modules 216 can be in communication with the computing hardware 218. The collector computing module 216a can perform remediation action at the computing hardware 218 in response to receiving the subsequent value of the first datatype of the telemetry data.

The collector computing module 216a performs the remediation action independent of user action by a user 250 of the information handling system. That is, the collector computing module 216a performs the remediation action at the information handling system 202 (and specifically, at the computing hardware 218) automatically in response to receiving the subsequent values of the datatypes of the telemetry data. The collector computing module 216a can perform the remediation action (or remediation actions) to provide operability of the computing features of the computing hardware 218 by improving performance capabilities of the information handling system 202 (such as the computing hardware 218). That is, performing the remediation action(s) to the computing hardware 218 by the collector computing module 216a improves the performance capabilities of the information handling system 202 (the computing hardware 218) such that the functionality and the operability of the computing features of the computing hardware 218 is improved. In some examples, the collector computing module 216a can perform the remediation action (or remediation actions) to improve the performance capabilities of the information handling system 202 without user action/input by the user 250 (independent of user action/input by the user 250).

In some examples, the first datatype of the telemetry data can include a type of power —AC or battery. In some examples, the collector computing module 216a, in response to receiving the subsequent value of the first datatype of the telemetry data that indicates the power source of the information handling system 202 is AC power, can perform the remediation action of disabling any battery related operations, such as battery-related data operations for determining a health of the battery without input/interaction by the user 250.

In some examples, the first datatype of the telemetry data can include a type of power —AC or battery. In some examples, the collector computing module 216a, in response to receiving the subsequent value of the first datatype of the telemetry data that indicates the power source of the information handling system 202 is battery power, can perform the remediation action of disabling or throttling power intensive applications and computing hardware, such as determination of the network utilization, display properties such as brightness, and processing speed of computing hardware without input/interaction by the user 250.

In some examples, the first datatype of the telemetry data can include a hinge angle. In some examples, the collector computing module 216a, in response to receiving the subsequent value of the first datatype of the telemetry data that indicates the hinge angle of the information handling system 202 (between bodies of the information handling system 202), can perform the remediation action of adjusting a display state of the information handling system 202 without input/interaction by the user 250 based on the hinge angle (indicating table top mode, book mode, or standard mode).

In some examples, the first datatype of the telemetry data can include network connectivity state (Wi-FI, Ethernet, Cellular). In some examples, the collector computing module 216a, in response to receiving the subsequent value of the first datatype of the telemetry data that indicates the network connectivity state of the information handling system 202, can perform the remediation action of adjusting network transmission rates without input/interaction by the user 250.

In some examples, the collector computing module 216a, in response to receiving the subsequent value of the first datatype of the telemetry data, can perform the remediation action of uninstalling a driver associated with an appropriate computing hardware 218 without input/interaction by the user 250. That is, the collector computing module 216a can uninstall, or facilitate uninstallation of, the driver at the appropriate computing hardware 218 automatically in response to receiving the subsequent value of the first datatype of the telemetry data.

In some examples, the collector computing module 216a, in response to receiving the subsequent value of the first datatype of the telemetry data, can perform the remediation action of updating a driver associated with an appropriate computing hardware 218 without input/interaction by the user 250. That is, the collector computing module 216a can update, or facilitate updating of, the driver at the appropriate computing hardware 218 automatically in response to receiving the subsequent value of the first datatype of the telemetry data.

In some examples, the collector computing module 216a, in response to receiving the subsequent value of the first datatype of the telemetry data, can perform the remediation action of disabling a driver associated with an appropriate computing hardware 218 without input/interaction by the user 250. That is, the collector computing module 216a can disable, or facilitate disabling of, the driver at the appropriate computing hardware 218 automatically in response to receiving the subsequent value of the first datatype of the telemetry data.

In some examples, the collector computing module 216a, in response to receiving the subsequent value of the first datatype of the telemetry data, can perform the remediation action of installing a new driver associated with an appropriate computing hardware 218 without input/interaction by the user 250. That is, the collector computing module 216a can install, or facilitate installing of, the driver at the appropriate computing hardware 218 automatically in response to receiving the subsequent value of the first datatype of the telemetry data.

In some examples, the collector computing module 216a, in response to receiving the subsequent value of the first datatype of the telemetry data, can perform the remediation action of updating firmware associated with an appropriate computing hardware 218 without input/interaction by the user 250. That is, the collector computing module 216a can update, or facilitate updating of, the firmware at the appropriate computing hardware 218 automatically in response to receiving the subsequent value of the first datatype of the telemetry data.

In some examples, the collector computing module 216a, in response to receiving the subsequent value of the first datatype of the telemetry data, can perform the remediation action of updating a configuration associated with an appropriate computing hardware 218 without input/interaction by the user 250. That is, the collector computing module 216a can update, or facilitate updating of, the configuration at the appropriate computing hardware 218 automatically in response to receiving the subsequent value of the first datatype of the telemetry data.

Furthermore, after the telemetry data collection computing module 210 provides the subsequent value of the first datatype of the telemetry data (at 326), the telemetry data collection computing module 210 determines whether there is another datatype of telemetry data that has subsequent values (as obtained at 316). In some examples, when the telemetry data collection computing module 210 determines that there is another datatype of telemetry data that has subsequent values (at 330), the method proceeds back to step 318. Specifically, the telemetry data collection computing module 210 proceeds with a second datatype of the telemetry data.

In some examples, when the telemetry data collection computing module 210 determines that there is not another datatype of telemetry data that has subsequent values, the telemetry data collection computing module 210 determines whether there is another request from another collector computing module 216. When the telemetry data collection computing module 210 determines that this is another request from another collector computing module 216 (at 332), the method proceeds to step 308. When the telemetry data collection computing module 210 determines that this is not another request from another collector computing module 216 (at 332), the method proceeds to step 316.

In some examples, the telemetry data collection computing module 210 can determine that the subsequent value of the first datatype is the same as the initial value of the first datatype (at 320), and in response, proceed to step 330. The telemetry data collection computing module 210 can determine that there is not another datatype of telemetry data that has subsequent values (at 330), and proceed to step 332; the telemetry data collection computing module 210 can determine that this is not another request from another collector computing module 216, and proceed to step 316.

The telemetry data collection computing module 210 can obtain, at a third time after the second time and from the computing hardware 218, further subsequent values of each of the plurality of datatypes of the telemetry data, at 316. That is, the telemetry data collection computing module 210 contacts the computing hardware 218, and polls (invokes) the computing hardware 218 for further subsequent values of the respective telemetry data associated with each of the computing hardware 218.

The telemetry data collection computing module 210 can compare, for each datatype of telemetry data, the initial value of the datatype to the subsequent value of the datatype, at 318. Specifically, the telemetry data collection computing module 210 can compare, for the first datatype of telemetry data, the subsequent value of the first datatype to the further subsequent value of the first datatype. The telemetry data collection computing module 210 can determine, based on the comparing, whether the subsequent value of the first datatype is different from the further subsequent value of the first datatype, at 320.

In some examples, the telemetry data collection computing module 210 can determine that the further subsequent value of the first datatype is different from the subsequent value of the first datatype (at 320), and in response, updates the table 260 for the first datatype of the telemetry data, at 322. Specifically, the telemetry data collection computing module 210 updates, at the table 260 for the first datatype of the telemetry data, the subsequent value to the further subsequent value when the further subsequent value of the first datatype is different from the subsequent value of the first datatype.

The telemetry data collection computing module 210 can identify, based on the table 260, one or more subscribers of the first datatype of the telemetry data, at 324. For example, for the first datatype of telemetry data, the table 260 can indicate that the collector computing module 216a is a subscriber of the first datatype of telemetry data.

The telemetry data collection computing module 210 can provide, automatically and without user input and to the collector computing module 216, the further subsequent value of the first datatype of the telemetry data, at 326. That is, the telemetry data collection computing module 210 can provide, to the collector computing module 216a, a notification that the value of the first datatype of the telemetry data has changed, and further provide the further subsequent value of the first datatype of the telemetry data. The telemetry data collection computing module 210 can provide the further subsequent value of the first datatype of the telemetry data in response to determining that the further subsequent value of the first datatype is different from the subsequent value of the first datatype (at 320). That is, the telemetry data collection computing module 210 “pushes” the further subsequent value of the first datatype of the telemetry data to the collector computing module 216a automatically and without a “pull” request from the collector computing module 216a for each update of the value of the first datatype of the telemetry data. In other words, the telemetry data collection computing module 210 can provide the further subsequent value of the first datatype of the telemetry data to the collector computing module 216a automatically and without a request from the collector computing module 216a (outside of a request from the collector computing module 216a to be a subscriber of the first datatype of the telemetry data).

The collector computing module 216a can perform, based on the further subsequent value of the first datatype of the telemetry data, a remediation action at the computing hardware 218, at 328. The collector computing module 216a can perform the remediation action at the computing hardware 218 in response to receiving the further subsequent value of the first datatype of the telemetry data.

In some examples, the telemetry data collection computing module 210 can further detect any dependency cycles associated with the collector computing modules 216 and/or the computing hardware 218 and flag them the same. For example, if a global variable is declared that requires telemetry data such as the power state of the computing hardware 218, and the collector computing module 216 for that power state needs another global variable managed by a different collector computing module 216 that depends on the first one, the telemetry data collection computing module 210 will identify this cycle. The telemetry data collection computing module 210 can provide an alert of the detected cycle and indicate that it cannot populate the required data due to this dependency issue.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A computer-implemented method of managing telemetry data collection at an information handling system, the method comprising:
identifying a plurality of datatypes of telemetry data, each datatype of the plurality of datatypes of telemetry data associated with computing hardware of the information handling system;
obtaining, at a first time and from the computing hardware, initial values of each of the plurality of datatypes of the telemetry data;
storing, at a table, the initial values of each of the plurality of datatypes of the telemetry data;
receiving, from a first collector computing module, a request for a value of a first datatype of the plurality of datatypes of the telemetry data;
in response to receiving the request:
registering the first collector computing module as a subscriber of the first datatype of the telemetry data;
providing, to the first collector computing module, the initial value indicated by the table for the first datatype of the telemetry data;
obtaining, at a second time after the first time, a subsequent value of each of the plurality of datatypes of the telemetry data, including:
subscribing to, for a particular datatype of the plurality of datatypes, updates to the particular datatype from the computing hardware associated with the particular datatype when an event condition occurs at the information handling system; and
receiving, from the hardware device associated with the particular datatype, the subsequent value to the particular datatype in response to the event condition occurring;
comparing, for the first datatype of the telemetry data, the initial value of the first datatype to the subsequent value of the first datatype;
determining, based on the comparing, that the subsequent value of the first datatype is different from the initial value of the first datatype, and in response:
updating, at the table for the first datatype of the telemetry data, the initial value to the subsequent value;
identifying, based on the table, one or more subscribers of the first datatype of the telemetry data;
providing, automatically and without user input and to the first collector computing module, the subsequent value of the first datatype of the telemetry data; and
performing, at the first collector computing module and based on the subsequent value of the first datatype of the telemetry data, a remediation action at one or more of the computing hardware of the information handling system.

2. The computer-implemented method of claim 1, further including:
providing data indicating the table to the first collector computing module of the information handling system.

3. The computer-implemented method of claim 1, further including:
determining, based on the comparing, that the subsequent value of the first datatype is the same as the initial value of the first datatype, and in response:
obtaining, at a third time after the second time, a further subsequent value of each of the plurality of datatypes of the telemetry data.

4. The computer-implemented method of claim 3, further including:
comparing, for the first datatype, the subsequent value of the first datatype to the further subsequent value of the first datatype;
determining, based on the comparing, that the further subsequent value of the first datatype is different from the subsequent value of the first datatype, and in response:
updating, at the table for the first datatype, the subsequent value to the further subsequent value;
identifying, based on the table, one or more subscribers of the first datatype of the telemetry data;
providing, automatically and without user input and to the first collector computing module, the further subsequent value of the first datatype of the telemetry data; and
performing, at the first collector computing module and based on the further subsequent value of the first datatype of the telemetry data, a remediation action at one or more of the computing hardware of the information handling system.

5. An information handling system comprising a processor having access to memory media storing instructions executable by the processor to perform operations, comprising:
identifying a plurality of datatypes of telemetry data, each datatype of the plurality of datatypes of telemetry data associated with computing hardware of the information handling system;
obtaining, at a first time and from the computing hardware, initial values of each of the plurality of datatypes of the telemetry data;
storing, at a table, the initial values of each of the plurality of datatypes of the telemetry data;
receiving, from a first collector computing module, a request for a value of a first datatype of the plurality of datatypes of the telemetry data;
in response to receiving the request:
registering the first collector computing module as a subscriber of the first datatype of the telemetry data;
providing, to the first collector computing module, the initial value indicated by the table for the first datatype of the telemetry data;
obtaining, at a second time after the first time, subsequent values of each of the plurality of datatypes of the telemetry data, including:
subscribing to, for a particular datatype of the plurality of datatypes, updates to the particular datatype from the computing hardware associated with the particular datatype when an event condition occurs at the information handling system; and
receiving, from the hardware device associated with the particular datatype, the subsequent value to the particular datatype in response to the event condition occurring;
comparing, for the first datatype of the telemetry data, the initial value of the first datatype to the subsequent value of the first datatype;
determining, based on the comparing, that the subsequent value of the first datatype is different from the initial value of the first datatype, and in response:
updating, at the table for the first datatype of the telemetry data, the initial value to the subsequent value;
identifying, based on the table, one or more subscribers of the first datatype of the telemetry data;
providing, automatically and without user input and to the first collector computing module, the subsequent value of the first datatype of the telemetry data; and
performing, at the first collector computing module and based on the subsequent value of the first datatype of the telemetry data, a remediation action at one or more of the computing hardware of the information handling system.

6. The information handling system of claim 5, the operations further including:
providing data indicating the table to the first collector computing module of the information handling system.

7. The information handling system of claim 5, the operations further including:
determining, based on the comparing, that the subsequent value of the first datatype is the same as the initial value of the first datatype, and in response:
obtaining, at a third time after the second time, a further subsequent value of each of the plurality of datatypes of the telemetry data.

8. The information handling system of claim 7, the operations further including:
comparing, for the first datatype, the subsequent value of the first datatype to the further subsequent value of the first datatype;
determining, based on the comparing, that the further subsequent value of the first datatype is different from the subsequent value of the first datatype, and in response:
updating, at the table for the first datatype, the subsequent value to the further subsequent value;
identifying, based on the table, one or more subscribers of the first datatype of the telemetry data;
providing, automatically and without user input and to the first collector computing module, the further subsequent value of the first datatype of the telemetry data; and
performing, at the first collector computing module and based on the further subsequent value of the first datatype of the telemetry data, a remediation action at one or more of the computing hardware of the information handling system.

9. A non-transitory computer-readable medium storing software comprising instructions executable by one or more computers which, upon such execution, cause the one or more computers to perform operations comprising:
identifying a plurality of datatypes of telemetry data, each datatype of the plurality of datatypes of telemetry data associated with computing hardware of the information handling system;
obtaining, at a first time and from the computing hardware, initial values of each of the plurality of datatypes of the telemetry data;
storing, at a table, the initial values of each of the plurality of datatypes of the telemetry data;
receiving, from a first collector computing module, a request for a value of a first datatype of the plurality of datatypes of the telemetry data;
in response to receiving the request:
registering the first collector computing module as a subscriber of the first datatype of the telemetry data;
providing, to the first collector computing module, the initial value indicated by the table for the first datatype of the telemetry data;
obtaining, at a second time after the first time, subsequent values of each of the plurality of datatypes of the telemetry data, including:
subscribing to, for a particular datatype of the plurality of datatypes, updates to the particular datatype from the computing hardware associated with the particular datatype when an event condition occurs at the information handling system; and
receiving, from the hardware device associated with the particular datatype, the subsequent value to the particular datatype in response to the event condition occurring;
comparing, for the first datatype of the telemetry data, the initial value of the first datatype to the subsequent value of the first datatype;
determining, based on the comparing, that the subsequent value of the first datatype is different from the initial value of the first datatype, and in response:
updating, at the table for the first datatype of the telemetry data, the initial value to the subsequent value;
identifying, based on the table, one or more subscribers of the first datatype of the telemetry data;
providing, automatically and without user input and to the first collector computing module, the subsequent value of the first datatype of the telemetry data; and
performing, at the first collector computing module and based on the subsequent value of the first datatype of the telemetry data, a remediation action at one or more of the computing hardware of the information handling system.

10. The non-transitory computer-readable medium of claim 9, the operations further including:
providing data indicating the table to the first collector computing module of the information handling system.

11. The non-transitory computer-readable medium of claim 9, the operations further including:
determining, based on the comparing, that the subsequent value of the first datatype is the same as the initial value of the first datatype, and in response:
obtaining, at a third time after the second time, a further subsequent value of each of the plurality of datatypes of the telemetry data.

12. The non-transitory computer-readable medium of claim 11, the operations further including:
comparing, for the first datatype, the subsequent value of the first datatype to the further subsequent value of the first datatype;
determining, based on the comparing, that the further subsequent value of the first datatype is different from the subsequent value of the first datatype, and in response:
updating, at the table for the first datatype, the subsequent value to the further subsequent value;
identifying, based on the table, one or more subscribers of the first datatype of the telemetry data;
providing, automatically and without user input and to the first collector computing module, the further subsequent value of the first datatype of the telemetry data; and
performing, at the first collector computing module and based on the further subsequent value of the first datatype of the telemetry data, a remediation action at one or more of the computing hardware of the information handling system.
